(19) United States
(12) Patent Application Publication
(10) Pub. No.: US 2004/0164541 A1
(43) Pub. Date: Aug. 26, 2004

(54) Binding assembly

(76) Inventor: Daniel Busatto, Paris (FR)

Correspondence Address: Mr. Alain M. Leclerc, C/O GOUDREAU GAGE DUBUC, Stock Exchange Tower, 800 Place Victoria, Suite 3400, Montreal, QC, H4Z 1E9, CA

(21) Appl. No.: 10/373,193

(22) Filed: Feb. 26, 2003

(51) Int. Cl. B42D 1/00

(52) U.S. Cl. 281/21.1

(57) ABSTRACT

A binding assembly for binding sheets having apertures configured to be bound thereby. The said binding assembly includes a tube assembly. The tube assembly is defined by separate first and second bodies. Each first and second bodies has mutually engaging mounting elements so as to be releasably mounted together. At least a portion of either of the first and second bodies is so configured and sized as to be fitted through the aperture of at least one sheet and as to be mounted to the other of the first and second body portions binding that sheet. Also disclosed are binders, albums and files including this binding assembly.

### FIELD OF THE INVENTION

The present invention relates to a binding assembly. More specifically, the present invention is concerned with binding assembly for binding sheets, as well as binders, albums or files including this binding assembly.

### BACKGROUND OF THE INVENTION

A variety of binding assemblies and apparatuses and binders including such assemblies and apparatuses are known in the art.

Most binders, albums or files include ring members that engage the sheet apertures, thus binding a variety of sheets and covers together. These ring members are usually one piece assemblies which are configured to open and close. Such ring binding assemblies are used for non-permanent binding enabling refill pages to be added or retrieved or pages to be removed, replaced or put in another order.

Improvements to conventional binding apparatuses include tubular members or drumrings for binding sheets having apertures configured to be bound thereby. The drumrings are more aesthetic than the conventional rings and unlike the conventional rings which can only be used in covers with two sides and one spine, the drumring enables to use two separate covers. Furthermore, drumring binding assemblies allow a bound page to be turned 3600 about the ring.

Even though drumrings on the market right now have a considerable aesthetic advantage with respect to rings, a drawback with prior art tubular assemblies or drumrings is that they are difficult to use and fragile.

There thus remains a need to provide an improved binding assembly.

### OBJECTS OF THE INVENTION

An object of the present invention is therefore to provide an improved binding assembly.

Another object of the invention is to provide an improved binder, album or file.

### SUMMARY OF THE INVENTION

More specifically, in accordance with the present invention, there is provided a binding assembly for binding sheets having apertures configured to be bound thereby, the binding assembly comprising:

a tube assembly, the tube assembly being defined by separate first and second bodies, each of the first and second bodies having mutually engaging mounting elements so as to be releasably mounted together;

whereby, at least a portion of either of the first and second bodies is so configured and sized as to be fitted through the aperture of at least one sheet and as to be mounted to the other of the first and second body portions binding that sheet.

In an embodiment, the binding assembly comprises a plurality of tube assemblies, the sheet including a plurality of corresponding apertures.

The sheets may be selected from the group consisting of paper, plastic, album pages.

In an embodiment, the mutual engaging mounting elements include protrusions and corresponding recesses configured for a mutual snap fit therewith. Alternatively, the mutual engaging mounting elements include protrusions and corresponding recesses configured for a mutual snug fit therewith. Alternatively, the mutual engaging mounting elements include locking portions configured for an interlocking fit.

In accordance with another aspect of the present invention there is provided a binder for binding sheets including apertures configured to bound thereby, the binder comprising:

front and back covers, each of the front and back covers having at least one respective aperture; and

a binding assembly for binding the front and back covers and at least one sheet therebetween, the binding assembly including

at least one tube assembly being defined by separate first and second bodies, each of the first and second bodies having mutually engaging mounting elements so as to be releasably mounted together; whereby, at least a portion of either of the first and second bodies is so configured and sized as to be fitted through the front and back cover apertures and through the aperture of the at least one sheet and as to be mounted to the other of the first and second bodies thus binding the front and back covers and the sheet therebetween.

The front and back covers may be made of material selected from the group consisting of metal, plastic, paper and wood.

The sheets are selected from the group consisting of paper, plastic and an album page. The binder may be an album or a file.

Except when otherwise indicated the terms “first” and “second” are used herein for indicative purposes and as such are reversible.

The term “binding assembly” should be construed herein to include a given assembled tube assembly, a given disassembled tube assembly or the first and second bodies thereof, more than one assembled and/or disassembled tube assembly of the same or of various types or the first and second bodies of the more than one disassembled tube assemblies of the same or of various types.

The term “binder” should be construed herein to include a variety of binders, albums, files and the like commonly used to bind sheets.

The term “sheet” should be construed herein to include a variety of plastic and paper sheets, binder, album or file covers, loose-leaf pages, article-displaying pages and the like.

An advantage of the present invention is that it provides a binding assembly that is relatively easy to bind and unbind pages.

Other objects, advantages and features of the present invention will become more apparent upon reading of the following non restrictive description of preferred embodiments thereof, given by way of example only with reference to the accompanying drawings.

### BRIEF DESCRIPTION OF THE DRAWINGS

In the appended drawings like reference numerals denote like elements throughout and in which:

FIG. 1 is a perspective view of the binding assembly in accordance with an embodiment of the present invention;

FIG. 2 is a perspective view of the binding assembly of FIG. 1 with the first and second bodies of the tube assembly of the invention being separated;

FIG. 3 is a perspective view of the binding assembly in accordance with another embodiment of the present invention;

FIG. 4 is a perspective view of the binding assembly of FIG. 3 with the first and second bodies of the tube assembly of the invention being separated;

FIG. 5 is a perspective view of the binding assembly in accordance with a further embodiment of the present invention;

FIG. 6 is a perspective view of the binding assembly of FIG. 5 with the first and second bodies of the tube assembly of the invention being separated;

FIG. 7 is a perspective view of the binding assembly in accordance with yet another embodiment of the present invention with one of the two bodies of the assembly represented in dotted line;

FIG. 8 is a perspective view of the binding assembly of FIG. 5 with the first and second bodies of the tube assembly of the invention being separated;

FIG. 9 is a perspective view of the binding assembly in accordance with yet a further embodiment of the present invention bound to two sheets;

FIG. 10 is a perspective view of the binding assembly in accordance with still yet another embodiment of the present invention bound to two sheets; and

FIGS. 11A, 11B and 11C are respectively three sectional bottom views of an album, binder or file bound by three different embodiments of the binding assembly.

### DESCRIPTION OF THE EMBODIMENTS

With reference to the accompanying drawings, embodiments of the invention will be herein described.

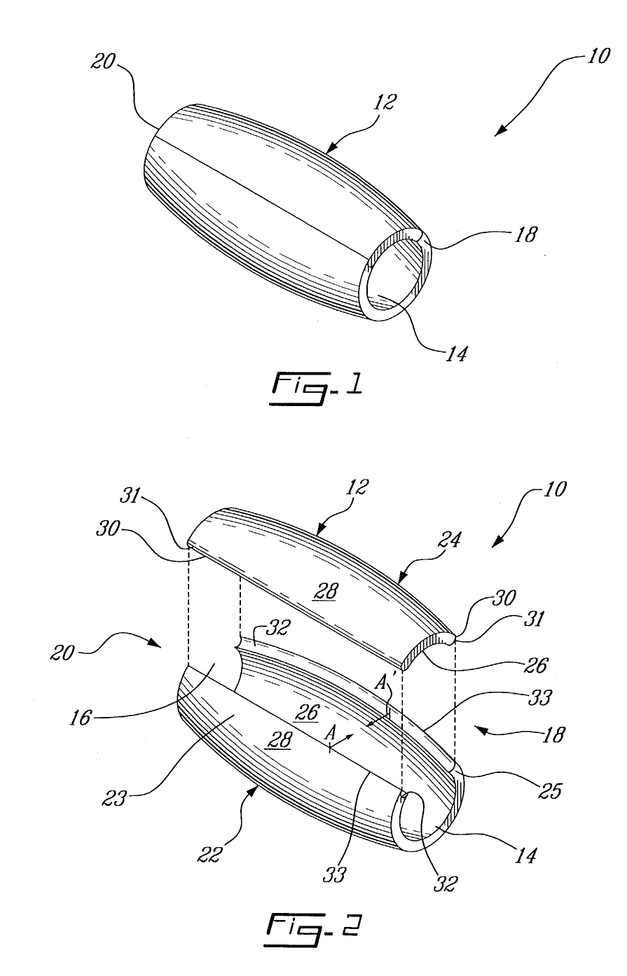

FIG. 1 shows a binding assembly 10, in accordance with an embodiment of the invention.

The binding assembly 10 includes a tube assembly 12 having a generally hollow cylindrical and oval configuration with apertures 14 and 16 (see FIG. 2) at both its ends 18 and 20 respectively.

As shown in FIG. 2, the tube assembly 12 is defined by two separate first and second bodies 22 and 24 respectfully, which are mounted together and which can be separated, as will be explained below. Bodies 22 and 24 have respective concave inner faces 26 and respective convex outer faces 28. In the non-limiting example shown here, the first body 22 is larger than the second body 24 and includes first and second side flaps 23 and 25 respectively.

First and second bodies 22 and 24 include mutually engaging mounting elements 30 and 32 respectively on their respective side edges 31 and 33. In this non-limiting example, elements 30 are protruding-surfaces and elements 32 are corresponding recessed-surfaces. A recess-surface 30 and protruding-surface 32 are configured for a mutual interference and releasable snap fit.

When bodies 22 and 24 are mounted together to form tube assembly 12, they may be separated by pushing the side flaps 23 and 25 of body 22 inwardly as shown by arrows A and A′ releasing the protruding-surface 32 from its mutual interference snap fit with the corresponding recess surface 30 as shown in FIG. 2.

FIG. 3 shows a binding assembly 34, in accordance with another embodiment of the invention.

The binding assembly 34 includes a tube assembly 36 similar to in configuration to tube assembly 10 and hence, need not be described further for the sole purpose of concision.

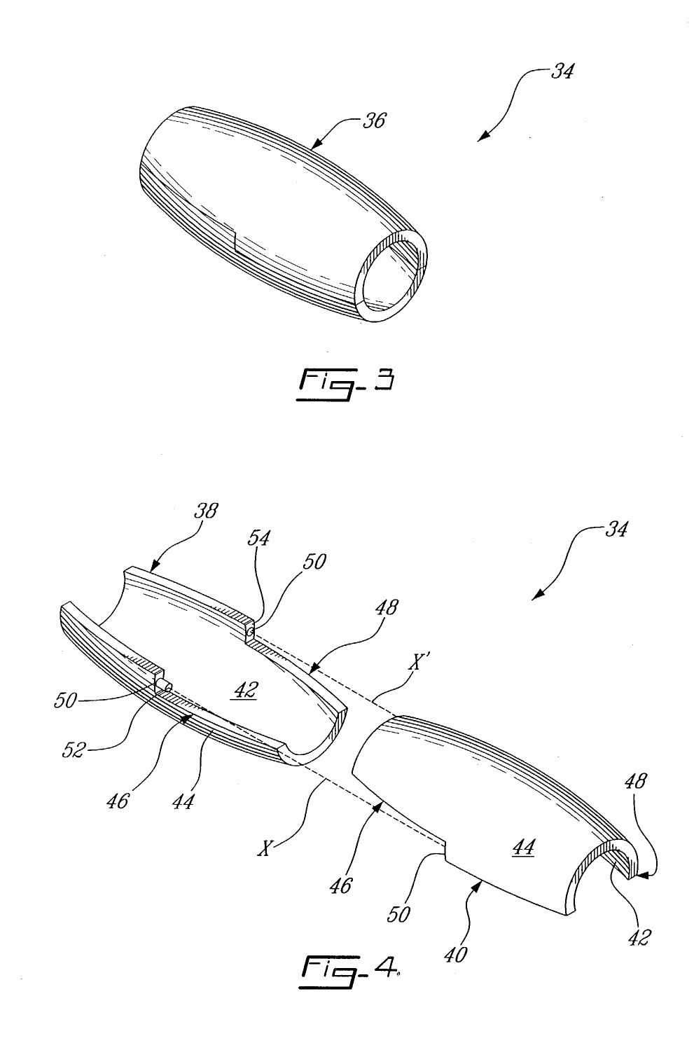

As shown in FIG. 4, the tube assembly 12 is defined by two separate first and second bodies 38 and 40 respectively, which are mounted together and which can be separated as will be explained below. Bodies 38 and 40 are half body portions of the tube assembly 34 and as such are mirror images of each other. Bodies 38 and 40 have respective concave inner faces 42 and respective convex outer faces 44.

The bodies 38 and 40 have respective first and second sides 46 and 48. Sides 46 and 48 are so configured as to define a shoulder 50.

Bodies 38 and 40 include respective mutual engaging elements 52 and 54 in the form of a protruding member and a corresponding recess respectively.

The first body 38 includes a protruding member 52 on the shoulder 50 of its first side 46 and a recess 54 on the shoulder 50 of its second side 48. Correspondingly, the second body 40 includes a recess 54 (not shown) on the shoulder 50 of its first side 46 and a protruding member 52 (not shown) formed on the shoulder 50 (not shown) of its second side 48. The protruding member 52 and recess 54 of body 38 respectively correspond to the recess 54 (not shown) and protruding member 52 (not shown) of body 40 for a mutual and releasable snug fit.

When bodies 38 and 40 are mounted together to form tube assembly 36 they may be separated by pushing the bodies 38 and 40 away from each other along the plane defined by dotted lines X and X′ with sufficient force so as to remove a protruding member 52 from a corresponding recess 54.

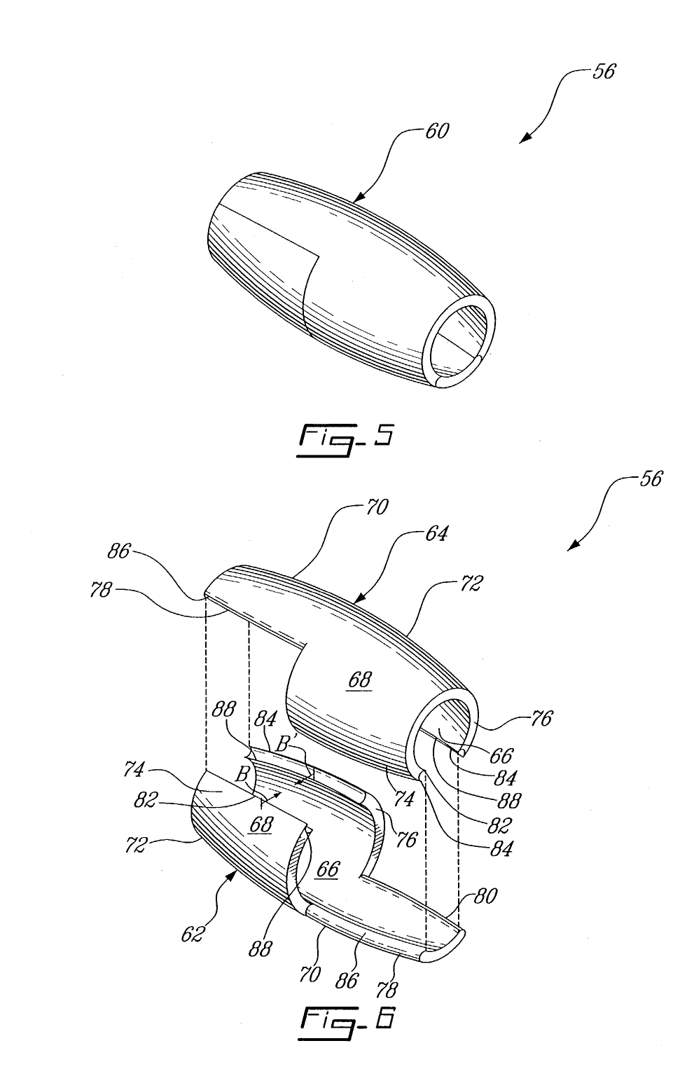

FIG. 5 shows a binding assembly 56, in accordance with yet another embodiment of the invention.

The binding assembly 58 includes a tube assembly 60 similar in configuration to tube assembly 10 and hence, like tube assembly 36 need not be described further for the sole purpose of concision

As shown in FIG. 6, the tube assembly 12 is defined by two separate first and second bodies 62 and 64 respectfully which are mounted together and which can be separated as will be explained below. Bodies 62 and 64 are half body portions of the tube assembly 56 and as such are mirror images of each other. Bodies 62 and 64 have respective concave inner faces 66 and respective convex outer faces 68.

The first and second bodies 62, and 64 include respective first and second body-portions 70 and 72. Each second body-portion 72 is larger that the first body-portion 70 of the same body 62 or 64 and includes first and second side flaps 74 and 76. First body-portions 70 have respective first and second side edges 78 and 80 (not shown for body 64). Body-portions 72 have respective first and second side edges 82 and 84.

First and second bodies 62 and 64 include mutually engaging mounting elements as will be explained below.

The first body-portion 70 of body 62 includes mounting elements 86 on its side edges 78 and 80 in the form of a protruding-surface. Correspondingly, the second body-portion 72 of body 64 includes mounting elements 88 on its side edges 82 and 84 in the form of a recessed-surface. The protruding-surfaces 86 of body 62 are configured to engage the recessed-surfaces 88 of the second body 64 in a mutual interference snap fit. Accordingly, the first body-portion 70 of body 64 includes mounting elements 86 on its side edges 78 and 80 (only one side edge 78 is shown here) the form of a protruding-surface. Correspondingly, the second body portion 72 of body 62 includes mounting elements 88 on its side edges 82 and 84 in the form of a recessed-surface. As before, the protruding-surfaces 86 of the second body 64 edges are configured to engage the recessed-surfaces 88 of the first body 62 in a mutual interference snap fit.

When bodies 62 and 64 are mounted together as shown in FIG. 5 to form the tube assembly 60, they may be separated by pushing the flaps 74 and 76 of bodies 62 and 64 inwardly, as shown by arrows B and B′, disengaging a protruding-surface 86 from its corresponding and complementary recessed-surface 88.

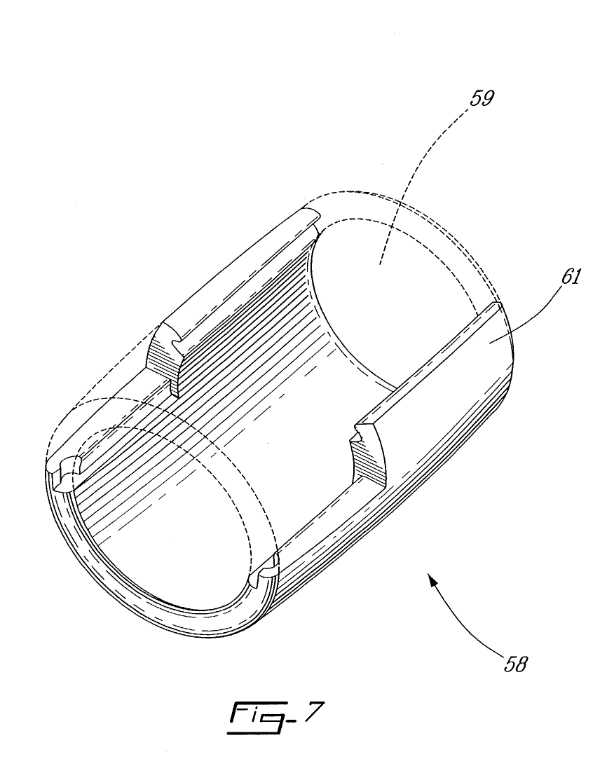

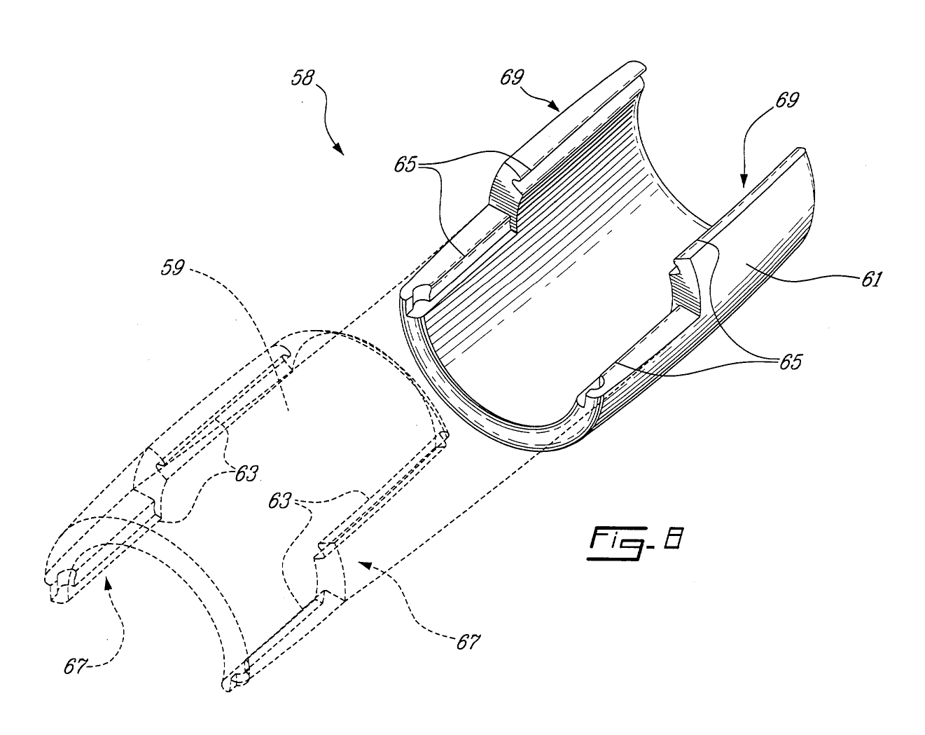

FIGS. 7 and 8 show a binding assembly 58 in accordance with another embodiment of the invention which includes first and second bodies 59 and 61. Bodies 59 and 61 include respective mutual engaging elements such as releasably locking portions 63 and 65, their respective side edges 67 and 69. Bodies 59 and 61 are mounted together by sliding their releasable locking portions 63 and 65 which act as complementary guides in an interlock fit as shown in FIG. 7, forming assembly 58. Bodies 59 and 61 can be separated by pushing them away from each other with sufficient force for sliding portions 63 and 65 in the opposite direction, as shown in FIG. 8.

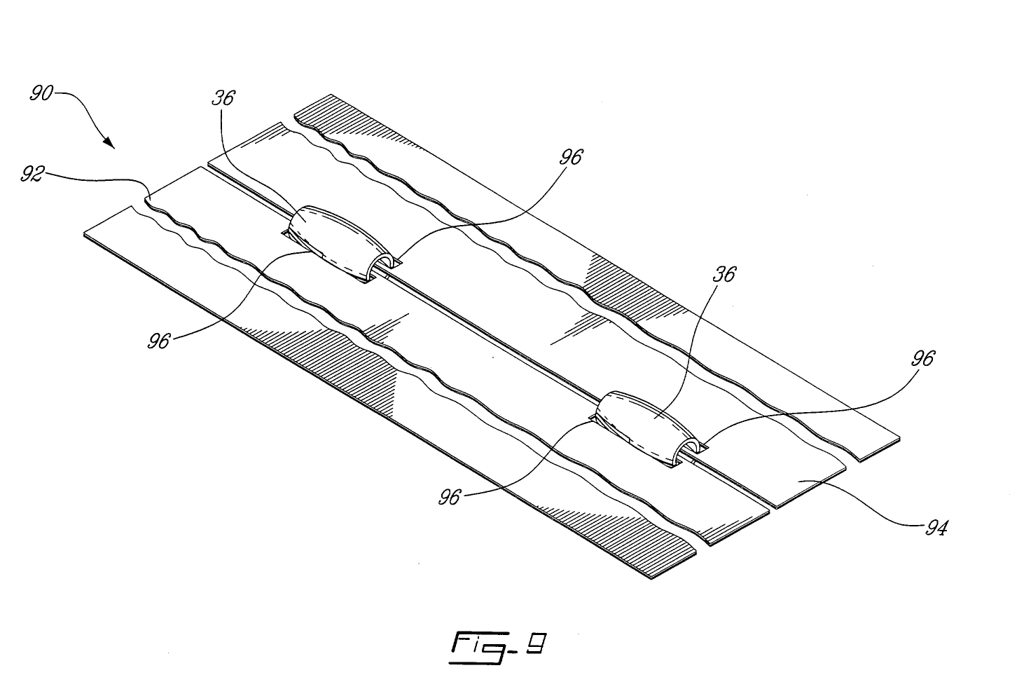

FIG. 9 shows a biding assembly 90 according to yet another embodiment of the present invention.

The binding assembly 90 includes two tube assemblies 36 previously described.

These tube assemblies 36 are shown binding sheets 92 and 94 at their apertures 96. Each sheet 92 and 94 has two apertures 96 that are configured to be bound by the binding assembly 90.

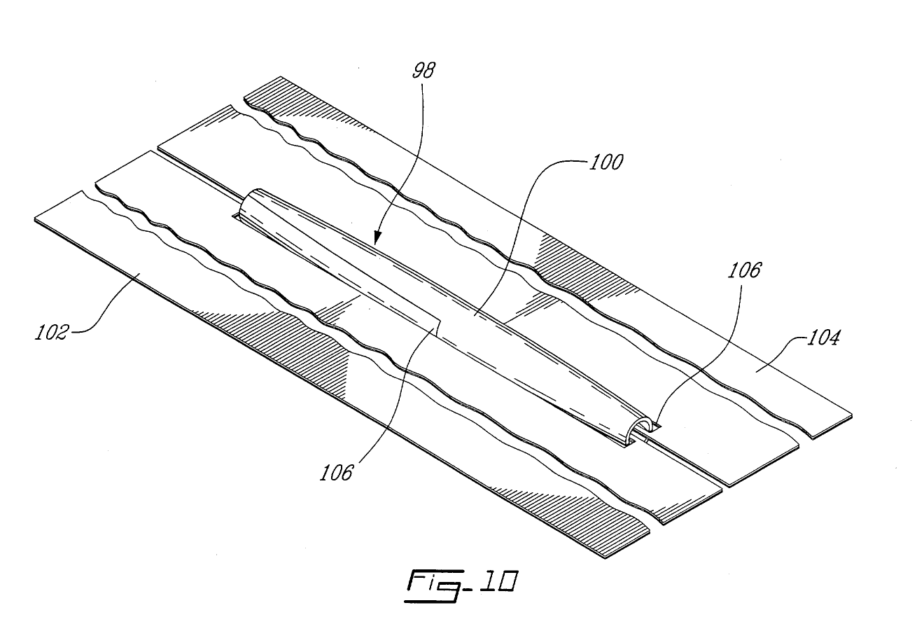

FIG. 10 shows a binding assembly 98 in accordance with yet a further embodiment of the present invention.

The binding assembly 98 includes a tube assembly 100 binding pages 102 and 104 at their apertures 106. Each sheet 102 and 104 includes one aperture 106 that is configured to be bound by the binding assembly 98. The tube assembly 100 is configured similarly to the tube assembly 36, yet is greater in size.

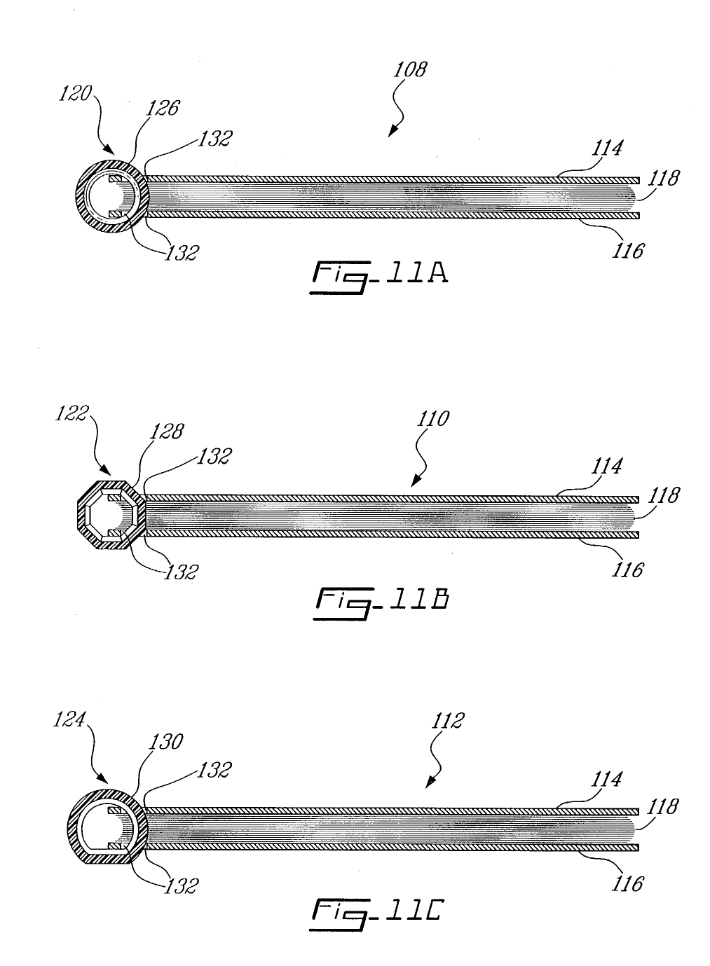

FIGS. 11A, 11B and 11C respectively show three embodiments of an album, binder or file 108, 110 and 112.

Each embodiment 108, 110 and 112 of the album, binder or file includes front and back covers 114, and 116 respectively and plurality of sheets 118 therebetween.

Furthermore, each embodiment 108, 110 and 112 of the album, binder or file includes a respective binding assembly 120, 122 and 124 including tube assemblies 126, 128 and 130 respectively. Each tube assembly 126, 128 and 130 binds the front and back covers 114 and 116 and the sheets 118 at their corresponding apertures, all of which have been generally denoted by reference 132.

It should be noted that given sheets used in the context of the present invention are provided with apertures configured to be bound by given embodiments of the binding assembly of the invention.

In operation, the user will disassemble the tube assembly or assemblies of a given binding assembly, for example tube assemblies 36 of binding assembly 90 in FIG. 9. Hence, each tube assembly 36 will be disassembled. One of the first or second bodies 38 or 40 or at least a portion thereof is configured to be fitted though apertures 90 of either or both sheets 92 and 94. Once one body is fitted though the apertures, the other body 38 or 40 will be mounted to that one body 38 and 40 as previously described. In this example there are two tube assemblies 36 and hence, this operation will be repeated for the other tube assembly 36 as well so as to bind sheets 92 and 94 together, as shown in FIG. 9.

A sheet 92 or 94 will be removed by disassembling the tube assemblies 36 as previously described.

The various binding assemblies of the present invention will bind a variety of sheets such as 92 and 94 in a similar fashion as well as covers 114 and 116 of binders 108, 110 and 112 with sheets 118 bound similarly therebetween (see FIGS. 11A, 11B and 11C).

In one non-limiting example, the sheets 118 are album pages configured to display photographs and hence, the binders 108, 110 and 112 are photo albums.

Having now described several embodiments of the invention as well as the operation of the invention, various other alternatives will be discussed herein as a way to exemplify further embodiments and not to limit the scope of the invention.

The binding assembly of the present invention may include a plurality of tube members each of which is configured to bind sheets at their apertures, which are configured to receive these tube assemblies therethrough.

The invention is not limited to the configuration and size of the tube assemblies 12, 36, 58, 60, 100, 126, 128 and 130; other suitable tube assemblies having a generally tubular configuration and having a variety of sizes to be fitted through a variety of apertures may be contemplated by the skilled artisan.

The tube assemblies of the present invention may be made of metallic material, plastic material or wood.

The invention is not limited to the complementary first and second bodies 22 and 24, 38 and 40, 59 and 61, 62 and 64; other suitable first and second bodies may be contemplated by the skilled artisan within the scope of the present invention. Hence, a variety of mutually engaging elements may also be contemplated.

The sheets of the present invention may be paper, plastic, display pages, covers for various types of binders which include albums and files. A variety of sheet aperture sizes and configurations may also be easily contemplated by the skilled artisan within the context of the present invention.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of preferred embodiments thereof, it can be modified, without departing from the spirit, scope and nature of the subject invention, as defined in the appended claims.

What is claimed is:

1. A binding assembly for binding sheets having apertures configured to be bound thereby, said binding assembly comprising:
a tube assembly, said tube assembly being defined by separate first and second bodies, each of said first and second bodies having mutually engaging mounting elements so as to be releasably mounted together;
whereby, at least a portion of either of said first and second bodies is so configured and sized as to be fitted through the aperture of at least one sheet and as to be mounted to the other of said first and second bodies binding that sheet.

2. A binding assembly according to claim 1, wherein said binding assembly comprises a plurality of tube assemblies, the sheet including a plurality of corresponding apertures.

3. A binding assembly according to claim 1, wherein the sheets are selected from the group consisting of paper, plastic, album pages.

4. A binding assembly according to claim 1, wherein said mutual engaging mounting elements include protrusions and corresponding recesses configured for a mutual snap fit therewith.

5. A binding assembly according to claim 1, wherein said mutual engaging mounting elements include protrusions and corresponding recesses configured for a mutual snug fit therewith.

6. A binding assembly according to claim 1, wherein said mutual engaging mounting elements include locking portions configured for an interlocking fit.

7. A binder for binding sheets including apertures configured to bound thereby, said binder comprising:
front and back covers, each of said front and back covers having at least one respective aperture; and
a binding assembly for binding said front and back covers and at least one sheet therebetween, said binding assembly including
at least one tube assembly being defined by separate first and second bodies, each of said first and second bodies having mutually engaging mounting elements so as to be releasably mounted together; whereby, at least a portion of either of said first and second bodies is so configured and sized as to be fitted through the front and back cover apertures and through the aperture of the at least one sheet and as to be mounted to the other of said first and second bodies thus binding said front and back covers and the sheet therebetween.

8. A binder according to claim 7, wherein said binding assembly includes a plurality of tube assemblies, said front and back cover and the sheet including a corresponding plurality of apertures.

9. A binder according to claim 7, wherein said front and back covers are made of material selected from the group consisting of metal, plastic, paper and wood.

10. A binder according to claim 7, wherein the sheets are selected from the group consisting of paper, plastic and an album page.

11. A binder according to claim 7, wherein the binder is an album.

12. A binder according to claim 7, wherein the binder is a file.

13. A binder according to claim 7, wherein said mutual engaging mounting elements include protrusions and corresponding recesses configured for a mutual snap fit therewith.

14. A binding assembly according to claim 7, wherein said mutual engaging mounting elements include protrusions and corresponding recesses configured for a mutual snug fit therewith.

15. A binding assembly according to claim 7, wherein said mutual engaging mounting elements include locking portions configured for an interlocking fit.
